(19) United States
(12) Patent Application Publication
(10) Pub. No.: US 2012/0232741 A1
(43) Pub. Date: Sep. 13, 2012

(54) DRIVING EVALUATION SYSTEM, VEHICLE-MOUNTED MACHINE, AND INFORMATION PROCESSING CENTER

(75) Inventors: Hiroaki Sekiyama, Tokyo (JP); Toshiyuki Namba, Tokyo (JP); Shojiro Takeuchi, Tokyo (JP); Keisuke Okamoto, Tokyo (JP); Yoshihiro Ooe, Kawasaki-shi (JP); Yoshihiro Suda, Tokyo (JP); Yoichi Sato, Tokyo (JP); Daisuke Yamaguchi, Tokyo (JP); Shiro Kumano, Kamakura (JP); Takashi Ichihara, Kobe-shi (JP)

(73) Assignees: THE FOUNDATION FOR THE PROMOTION OF INDUSTRIAL SCIENCE, Tokyo (JP); TOYOTA JIDOSHA KABUSHIKI KAISHA, Toyota-shi, Aichi (JP)

(21) Appl. No.: 13/496,777

(22) PCT Filed: Jun. 29, 2010
(86) PCT No.: PCT/JP2010/061040

§ 371 Date: May 25, 2012

(30) Foreign Application Priority Data
Sep. 18, 2009 (JP) 2009-217030

(51) Int. Cl. G06F 19/00

(52) U.S. Cl. 701/29.1

(57) ABSTRACT

An eco-driving probability density estimation unit and an eco-driving awareness pre-learning unit resets an evaluation standard of driving of a driver of a host vehicle for each condition in which the host vehicle is driven for each driving evaluation. Therefore, it becomes possible to set the evaluation standard of the driving in accordance with an actual condition during evaluation compared to a case where the standard for uniformly evaluating the driving is set. An eco-driving capability/proficiency estimation unit and an eco-driving awareness estimation unit evaluate the driving of the driver of the host vehicle by the evaluation standard reset by the eco-driving probability density estimation unit and the eco-driving awareness pre-learning unit. Therefore, it becomes possible to perform driving evaluation more suitable for the actual condition.

### TECHNICAL FIELD

The present invention relates to a driving evaluation system, a vehicle-mounted machine, and an information processing center. In particular, the present invention relates to a driving evaluation system, a vehicle-mounted machine, and an information processing center which evaluate the driving of a driver of a vehicle in each condition in which the vehicle is driven.

### BACKGROUND ART

A technique has been proposed which evaluates driving of a driver of a vehicle, and increases awareness of the driver about safe driving or low fuel-consumption driving (hereinafter, called eco-driving). For example, Patent Literature 1 describes a device which detects and records a driving condition of a vehicle, determines a safe driving behavior of a driver on the basis of the recorded driving condition of the vehicle, evaluates the degree of safe driving of the driver on the basis of the determination result, and records the degree of safe driving of the evaluation result.

### CITATION LIST

### Patent Literature

[Patent Literature 1] Japanese Unexamined Patent Application Publication No. 2002-225586

### SUMMARY OF INVENTION

### Technical Problem

On the other hand, in the above-described technique, in regard to the standard for evaluating the driving of the driver, a given standard is set in each driving condition of a general road, a highway, a city road, a hill, and a heavy traffic road. For example, as a standard for evaluating safe driving, in a highway rather than a general road, the reference value of the vehicle speed is set to be high. As a standard for evaluating eco-driving, in a heavy traffic road rather than a general road, the reference value of mileage or an accelerator control input is set to be high. These reference values are determined by data measured when a vehicle for measurement travels a road on which an ordinary vehicle travels or a simulated course, such as a test course.

However, as described above, for each condition in which a vehicle is driven, when the standard for uniformly evaluating driving is set, even if the driver carried out driving while being aware of safe driving or eco-driving during actual traveling of the vehicle, there may be difficulty in driving. In actuality, even at the same place or the same time, the difficulty of safe driving or eco-driving may change in various ways due to the condition of the host vehicle, such as speed, and the influence of peripheral vehicles, such as congestion. For this reason, there is a difference between the evaluation result of the driving determined by the device or system and effort or awareness of the driver about his/her driving. Accordingly, in the above-described technique, when the standard for uniformly evaluating the driving is set, since driving evaluation does not match the effort of the driver, the driver may feel a sense of discomfort. In this case, finally, the driver loses confidence in the device or system and does not keep using the device or system. This becomes particularly problematic for eco-driving where it is necessary for a plurality of drivers to exert effort over a long period of time.

The invention has been finalized in consideration of the actual condition, and an object of the invention is to provide a driving evaluation system, a vehicle-mounted machine, and an information processing center capable of performing driving evaluation more suitable for the actual condition.

### Solution to Problem

The invention provides a driving evaluation system. The driving evaluation system includes an evaluation standard resetting unit which resets an evaluation standard of driving of a driver of one vehicle for each condition in which the one vehicle is driven for each driving evaluation, and an evaluation unit which evaluates the driving of the driver of the one vehicle by the evaluation standard reset by the evaluation standard resetting unit.

With this configuration, the evaluation standard resetting unit resets the evaluation standard of the driving of the driver of the one vehicle for each condition, in which one vehicle is driven, that is, the state of the traveling road, such as road alignment or inclination, the state of the host vehicle, such as speed, and the condition of peripheral vehicles, such as congestion, for each driving evaluation. For this reason, it becomes possible to set the evaluation standard of the driving in accordance with the actual condition at the time of evaluation compared to a case where the standard for uniformly evaluating the driving is set. The evaluation unit evaluates the driving of the driver of the one vehicle by the evaluation standard reset by the evaluation standard resetting unit. For this reason, it becomes possible to perform driving evaluation more suitable for the actual condition.

In this case, the evaluation standard resetting unit may estimate, as the evaluation standard, the probability distribution of evaluation values of driving for each condition in which the one vehicle is driven, and the evaluation unit may evaluate the driving of the driver of the one vehicle on the basis of the probability distribution of the evaluation values in the condition in which the one vehicle is driven and evaluation values of actual driving of the one vehicle in the condition in which the one vehicle is driven.

With this configuration, the evaluation standard resetting unit estimates, as the evaluation standard, the probability distribution of evaluation values of driving for each condition in which the one vehicle is driven. For this reason, it is possible to statistically quantify the difficulty of driving in the corresponding condition. The evaluation unit evaluates the driving of the driver of the one vehicle on the basis of the probability distribution of the evaluation values in the condition in which the one vehicle is driven and evaluation values of actual driving of the one vehicle in the condition in which the one vehicle is driven, making it possible to quantitatively perform driving evaluation to be more suitable for the actual condition on the basis of the statistic.

In this case, the evaluation standard resetting unit may estimate, as the evaluation standard, the probability distribution of evaluation values of driving of at least one of an unspecified number of vehicles for each condition in which the one vehicle is driven and an unspecified number of vehicles of the same type as the one vehicle for each condition in which the one vehicle is driven.

With this configuration, the evaluation standard resetting unit estimates, as the evaluation standard, the probability distribution of evaluation values of driving of at least one of an unspecified number of vehicles for each condition in which the one vehicle is driven and an unspecified number of vehicles of the same type as the one vehicle for each condition in which the one vehicle is driven. For this reason, in regard to the evaluation standard of the driving, it is possible to quantify the difficulty of driving in the corresponding condition more suitable for the actual condition on the basis of the statistic of driving of an unspecified number of vehicles.

The evaluation standard resetting unit may estimate, as the evaluation standard, a probability density function relating to the probability distribution of evaluation values of driving for each condition, in which the one vehicle is driven, by Kernel density estimation.

Alternatively, the evaluation standard resetting unit may estimate, as the evaluation standard, a probability density function relating to the probability distribution of the evaluation values of the driving for each condition, in which the one vehicle is driven, by approximation based on a contaminated normal distribution.

With this configuration, the evaluation standard resetting unit estimates, as the evaluation standard, a probability density function relating to the probability distribution of the evaluation values of the driving for each condition, in which the one vehicle is driven, by approximation based on a contaminated normal distribution. With the contaminated normal distribution, the number of samples can be reduced. For this reason, it becomes possible to reduce the calculation time for estimating the probability density function.

The evaluation standard resetting unit may estimate, as the evaluation standard, the awareness state of the driver of the one vehicle for each condition, in which the one vehicle is driven, from a driving operation for each condition in which the one vehicle is driven, and the evaluation unit may evaluate the driving of the driver of the one vehicle on the basis of the awareness state of the driver of the one vehicle estimated in the condition in which the one vehicle is driven and an actual driving operation of the driver of the one vehicle in the condition in which the one vehicle is driven.

With this configuration, the evaluation standard resetting unit estimates, as the evaluation standard, the awareness state of the driver of the one vehicle for each condition, in which the one vehicle is driven, from a driving operation for each condition in which the one vehicle is driven. For this reason, it is possible to appropriately estimate the awareness state of the driver in the corresponding condition. The evaluation unit evaluates the driving of the driver of the one vehicle on the basis of the awareness state of the driver of the one vehicle estimated in the condition in which the one vehicle is driven and an actual driving operation of the driver of the one vehicle in the condition in which the one vehicle is driven. For this reason, it is possible to evaluate the driving of the driver in the relation between the awareness state of the driver and the actual driving operation, making it possible to perform driving evaluation including the awareness of the driver about driving.

In this case, the evaluation standard resetting unit may estimate, as the evaluation standard, the awareness state of the driver of the one vehicle for each condition, in which the one vehicle is driven, from the statistic of the driving operation of the driver of the one vehicle for each condition in which the one vehicle is driven.

With this configuration, the evaluation standard resetting unit estimates, as the evaluation standard, the awareness state of the driver of the one vehicle for each condition, in which the one vehicle is driven, from the statistic of the driving operation of the driver of the one vehicle for each condition in which the one vehicle is driven. For this reason, it becomes possible to estimate the awareness state for the driver himself/herself of the one vehicle with high precision.

Alternatively, the evaluation standard resetting unit may estimate, as the evaluation standard, the awareness state of the driver of the one vehicle for each condition, in which the one vehicle is driven, from the statistic of driving operations of drivers of an unspecified number of vehicles for each condition in which the one vehicle is driven.

With this configuration, the evaluation standard resetting unit estimates, as the evaluation standard, the awareness state of the driver of the one vehicle for each condition, in which the one vehicle is driven, from the statistic of driving operations of drivers of an unspecified number of vehicles for each condition in which the one vehicle is driven. For this reason, even if a small amount of data is accumulated for the driver himself/herself of the one vehicle, it becomes possible to immediately estimate the awareness state of the driver of the one vehicle.

The evaluation standard resetting unit may estimate the awareness state of the driver of the one vehicle by a dynamic Bayesian network.

With this configuration, the evaluation standard resetting unit estimates the awareness state of the driver of the one vehicle by a dynamic Bayesian network. For this reason, it becomes possible to quantitatively estimate the causal relation of the driving operation with respect to the awareness state of the driver.

Alternatively, the evaluation standard resetting unit may estimate the awareness state of the driver of the one vehicle by a support vector machine.

With this configuration, the evaluation standard resetting unit estimates the awareness state of the driver of the one vehicle by a support vector machine. For this reason, even if a small amount of data is accumulated for estimation, it becomes possible to estimate the awareness state of the driver.

The condition in which the one vehicle is driven may include at least one of the time and place at which the one vehicle is driven.

With this configuration, the condition in which the one vehicle is driven includes at least one of the time and place at which the one vehicle is driven. For this reason, it is possible to evaluate the driving of the driver for the time or place at which the vehicle is driven.

The evaluation unit may evaluate the degree such that the driving of the driver of the one vehicle attains low fuel consumption.

Since the driving evaluation system of the invention can perform driving evaluation more suitable for the actual condition, the driver feels little sense of discomfort in the system and is likely to keep using the system. For this reason, it particularly becomes effective when eco-driving where efforts over a long period of time are important is evaluated.

The invention also provides a vehicle-mounted machine. The vehicle-mounted machine includes an evaluation unit which, for each condition in which a host vehicle is driven, evaluates driving of a driver of a host vehicle by an evaluation standard of the driving of the driver of the host vehicle reset for each driving evaluation.

In this case, the evaluation standard of the driving of the driver of the host vehicle may be the probability distribution of evaluation values of driving estimated for each condition in which the host vehicle is driven, and the evaluation unit may evaluate the driving of the driver of the host vehicle on the basis of the probability distribution of the evaluation values in the condition in which the host vehicle is driven and evaluation values of actual driving of the host vehicle in which the host vehicle is driven.

In this case, the evaluation standard of the driving of the driver of the host vehicle may be the probability distribution of evaluation values of driving of at least one of an unspecified number of vehicles estimated for each condition in which the host vehicle is driven and an unspecified number of vehicles of the same type as the host vehicle for each condition in which the host vehicle is driven.

As the evaluation standard of the driving of the driver of the host vehicle, a probability density function relating to the probability distribution of evaluation values of driving for each condition in which the host vehicle is driven may be estimated by Kernel density estimation.

Alternatively, as the evaluation standard of the driving of the driver of the host vehicle, a probability density function relating to the probability distribution of evaluation values of driving for each condition in which the host vehicle is driven may be estimated by approximation based on a contaminated normal distribution.

The evaluation standard of the driving of the driver of the host vehicle may be the awareness state of the driver of the host vehicle for each condition, in which the host vehicle is driven, estimated from a driving operation for each condition in which the host vehicle is driven, and the evaluation unit may evaluate the driving of the driver of the host vehicle on the basis of the awareness state of the driver of the host vehicle estimated in the condition in which the host vehicle is driven and an actual driving operation of the driver of the host vehicle in the condition in which the host vehicle is driven.

In this case, the evaluation standard of the driving of the driver of the host vehicle may be the awareness state of the driver of the host vehicle for each condition, in which the host vehicle is driven, estimated from the statistic of driving operations of the driver of the host vehicle for each condition in which the host vehicle is driven.

Alternatively, the evaluation standard of the driving of the driver of the host vehicle may be the awareness state of the driver of the host vehicle for each condition, in which the host vehicle is driven, estimated from the statistic of driving operations of drivers of an unspecified number of vehicles for each condition in which the host vehicle is driven.

The awareness state of the driver of the host vehicle may be estimated by a dynamic Bayesian network.

Alternatively, the awareness state of the driver of the host vehicle may be estimated by a support vector machine.

The condition in which the host vehicle is driven may include at least one of the time and place at which the host vehicle is driven.

The evaluation unit may evaluate the degree such that the driving of the driver of the host vehicle attains low fuel consumption.

The invention also provides an information processing center which sets an evaluation standard for evaluating driving of a driver of one vehicle. The information processing center includes an evaluation standard resetting unit which resets an evaluation standard of driving of a driver of one vehicle for each condition in which the one vehicle is driven for each driving evaluation.

In this case, the evaluation standard resetting unit may estimate, as the evaluation standard, the probability distribution of evaluation values of driving for each condition in which the one vehicle is driven.

In this case, the evaluation standard resetting unit estimates, as the evaluation standard, the probability distribution of evaluation values of driving of at least one of an unspecified number of vehicles for each condition in which the one vehicle is driven and an unspecified number of vehicles of the same type as the one vehicle for each condition in which the one vehicle is driven.

The evaluation standard resetting unit may estimate, as the evaluation standard, a probability density function relating to the probability distribution of evaluation values of driving for each condition, in which the one vehicle is driven, by Kernel density estimation.

Alternatively, the evaluation standard resetting unit may estimate, as the evaluation standard, a probability density function relating to the probability distribution of the evaluation values of the driving for each condition, in which the one vehicle is driven, by approximation based on a contaminated normal distribution.

The evaluation standard resetting unit may estimate, as the evaluation standard, the awareness state of the driver of the one vehicle for each condition, in which the one vehicle is driven, from a driving operation for each condition in which the one vehicle is driven.

In this case, the evaluation standard resetting unit may estimate, as the evaluation standard, the awareness state of the driver of the one vehicle for each condition, in which the one vehicle is driven, from the statistic of the driving operation of the driver of the one vehicle for each condition in which the one vehicle is driven.

Alternatively, the evaluation standard resetting unit may estimate, as the evaluation standard, the awareness state of the driver of the one vehicle for each condition, in which the one vehicle is driven, from the statistic of driving operations of drivers of an unspecified number of vehicles for each condition in which the one vehicle is driven.

The evaluation standard resetting unit may estimate the awareness state of the driver of the one vehicle by a dynamic Bayesian network.

Alternatively, the evaluation standard resetting unit may estimate the awareness state of the driver of the one vehicle by a support vector machine.

The condition in which the one vehicle is driven may include at least one of the time and place at which the one vehicle is driven.

The evaluation standard may be to evaluate the degree such that the driving of the driver of the one vehicle attains low fuel consumption.

### Advantageous Effects of Invention

According to the driving evaluation system, the vehicle-mounted machine, and the information processing center of the invention, it becomes possible to perform driving evaluation more suitable for the actual condition.

### BRIEF DESCRIPTION OF DRAWINGS

FIG. 1 is a block diagram showing the configuration of a driving diagnosis system according to an embodiment.

FIG. 2 is a sequence diagram showing an operation of a driving diagnosis system according to an embodiment.

FIG. 3 is a flowchart showing a procedure of an eco-driving probability density estimation process of FIG. 2.

FIG. 4 is a graph showing the relation between mileage m, an observation variable Z, and probability density p.

FIG. 5 is a graph showing a probability density function of probability density p with respect to mileage m and an observation variable Zt at a certain time t.

FIG. 6 is a flowchart showing a procedure of eco-driving awareness pre-learning of FIG. 2.

FIG. 7 is a state transition diagram relating to eco-driving awareness x and a driving operation z.

FIG. 8 is a state transition diagram showing a driving operation x with respect to single eco-driving awareness x.

FIG. 9 is a graph showing the relation between the statistic of a driving operation xi and probability.

FIG. 10 is a flowchart showing eco-driving awareness pre-learning using SVM.

FIG. 11 is a graph showing sample data of eco-driving awareness for observation variable data x1 and x2.

FIG. 12 is a diagram showing a classification function of eco-driving awareness in the graph of FIG. 12.

FIG. 13 is a flowchart showing a procedure of proficiency estimation of FIG. 2.

FIG. 14 is a graph showing eco-driving capability with respect to current mileage mt.

FIG. 15 is a diagram showing a display example of eco-driving capability and proficiency.

FIG. 16 is a flowchart showing a procedure of eco-driving awareness estimation of FIG. 2 using a dynamic Bayesian network.

FIG. 17 is a state transition diagram relating to a method of calculating posterior probability of an awareness state x from a driving operation z as an observation variable.

FIG. 18 is a flowchart showing a procedure of eco-driving awareness estimation using SVM.

FIG. 19 is a graph showing determination of the presence/absence of eco-driving awareness using a classification function of FIG. 13.

### DESCRIPTION OF EMBODIMENTS

Hereinafter, a driving evaluation system according to the invention will be described with reference to the drawings.

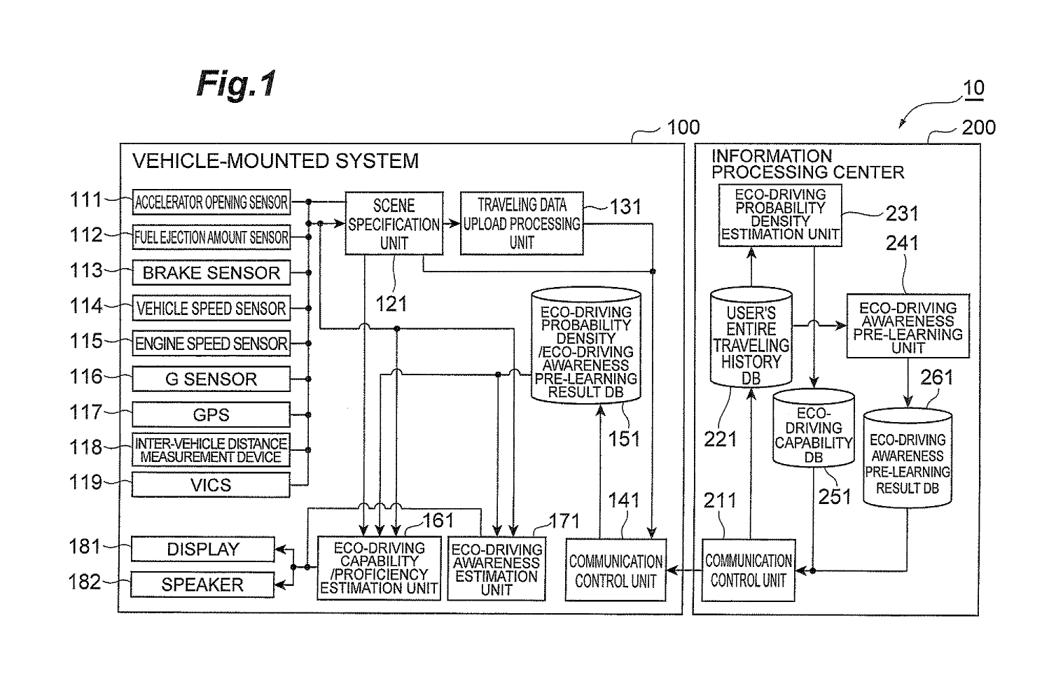

As shown in FIG. 1, a driving evaluation system 10 of this embodiment includes a vehicle-mounted system 100 and an information processing center 200. The driving evaluation system of this embodiment is a system which evaluates the degree of attainment of eco-driving of a driver of a host vehicle or awareness of the driver of the host driver about eco-driving. Specifically, in this embodiment, eco-driving capability, proficiency, and eco-driving awareness of the driver of the host vehicle are displayed, and advice based on these indexes is provided to the driver of the host vehicle.

The eco-driving capability is an index which represents the degree such that the driver of the host vehicle can improve evaluation values of driving, such as mileage, in a certain driving condition compared to a learning sample obtained from an individual driver or an unspecified number of drivers. When the eco-driving capability is small, advice which requests the driver to carry out driving as-is is provided to the driver. When the eco-driving capability is large, advice which requests the driver to further realize eco-driving is provided to the driver.

The proficiency is an index which represents how skilled the driver is at eco-driving in a certain driving condition compared to a learning sample obtained from an individual driver or an unspecified number of drivers. When the proficiency is low, advice indicating that the level of eco-driving is poor is provided to the driver. When the proficiency is high, advice indicating that the level of eco-driving is high is provided to the driver.

The eco-driving awareness is an index which represents whether or not the driver of the host vehicle carries out a driving operation while being aware of eco-driving in a certain driving condition compared to a learning sample obtained from an individual driver or an unspecified number of drivers. When the eco-driving awareness is low, advice which causes the driver to be aware of eco-driving is provided to the driver. When the eco-driving awareness is high, more accurate advice is provided to the driver such that the driver increases eco-driving awareness.

The vehicle-mounted system 100 is a vehicle-mounted machine which is mounted in each vehicle. The vehicle-mounted system 100 has sensors, such as an accelerator opening sensor 111, a fuel ejection amount sensor 112, a brake sensor 113, a vehicle speed sensor 114, an engine speed sensor 115, a G sensor 116, a GPS (Global Positioning System) 117, an inter-vehicle distance measurement device 118, and a VICS (Vehicle Information and Communication System) 119. The accelerator opening sensor 111 is a sensor which detects the accelerator opening of the host vehicle. The fuel ejection amount sensor 112 is a sensor which detects the fuel ejection amount into the cylinder. The brake sensor 113 is a sensor which detects the brake pedal control input of the host vehicle or the braking force to the wheel. The vehicle speed sensor 114 is a sensor which detects the vehicle speed of the host vehicle from the rotation speed of the axle of the wheel. The engine speed sensor 115 is a sensor which detects the engine speed of the host vehicle. The G sensor 116 is a sensor which detects the acceleration of the host vehicle or the inclination of a road on which the host vehicle travels. The GPS 117 is configured to receive signals from a plurality of GPS satellites by a GPS receiver and measures the position of the host vehicle from a difference between the signals. The inter-vehicle distance measurement device 118 is configured to measure the distance from a preceding vehicle or an obstacle using laser light or millimeter waves. The VICS 119 is a system which displays traffic information received from FM multiplex broadcasting, an optical beacon transmitter on a road, or the like in the form of figures and characters. Other sensors may be used to detect other factors, such as weather or a traveling time period, which will affect the driving operation of the driver.

The vehicle-mounted system 100 has a scene specification unit 121. The detection results of the accelerator opening sensor 111 to the GPS 117 are transmitted to the scene specification unit 121. In the scene specification unit 121, the position of the host vehicle specified by the GPS 117 and the like and map information (not shown) are used to specify a traveling road of the host vehicle. In the scene specification unit 121, a condition of a traveling road on which another host vehicle is driven, or a driving operation of a driver, such as vehicle speed or accelerator opening, is specified.

The vehicle-mounted system 100 has a traveling data upload processing unit 131. Information regarding the traveling road, the condition in which the host vehicle is driven, or the driving operation of the driver specified by the scene specification unit 121 is transmitted to the traveling data upload processing unit 131. The traveling data upload processing unit 131 converts the information regarding the condition, in which the host vehicle is driven, specified by the scene specification unit 121 in a format capable of being uploaded to the information processing center 200.

The vehicle-mounted system 100 has a communication control unit 141. Information regarding the traveling road, the condition in which the host vehicle is driven, or the driving operation of the driver converted by the traveling data upload processing unit 131 is uploaded to the information processing center 200 by the communication control unit 141. The communication control unit 114 downloads eco-driving probability density and an eco-driving awareness pre-learning result described below from the information processing center 200.

The vehicle-mounted system 100 has an eco-driving probability density/eco-driving awareness pre-learning result DB 151. The eco-driving probability density/eco-driving awareness pre-learning result DB 151 records the eco-driving probability density and the eco-driving awareness pre-learning result downloaded from the information processing center 200.

The vehicle-mounted system 100 has an eco-driving capability/proficiency estimation unit 161. The eco-driving capability/proficiency estimation unit 161 compares the eco-driving probability density recorded in the eco-driving probability density/eco-driving awareness pre-learning result DB 151 with the driving of the driver of the host vehicle detected from the sensors, such as the accelerator opening sensor 111, and calculates eco-driving capability and proficiency described below.

The vehicle-mounted system 100 has an eco-driving awareness estimation unit 171. The eco-driving awareness estimation unit 171 estimates the below-described eco-driving awareness of the driver from the eco-driving awareness pre-learning result recorded in the eco-driving probability density/eco-driving awareness pre-learning result DB 151 and the driving operation of the driver of the host vehicle.

The vehicle-mounted system 100 has a display 181 and a speaker 182. The display 181 and the speaker 182 display the eco-driving capability and proficiency estimated by the eco-driving capability/proficiency estimation unit 161 and the eco-driving awareness estimated by the eco-driving awareness estimation unit 171 for the driver.

The information processing center 200 has a communication control unit 211, a user's entire traveling history DB 221, an eco-driving probability density estimation unit 231, an eco-driving awareness pre-learning unit 241, an eco-driving capability DB 251, and an eco-driving, awareness pre-learning result DB 261. The communication control unit 211 receives information relating to the condition in which a vehicle of a user (a registered member) of the driving evaluation system 10 of this embodiment is driven or the driving operation of the driver from the vehicle-mounted system 100 which is mounted in the host vehicle or another vehicle.

The user's entire traveling history DB 221 records information relating to the condition in which the vehicle of each user is driven and the driving operation of the driver received by the communication control unit 211. As described below, the eco-driving probability density estimation unit 231 estimates eco-driving probability density which is the probability distribution of evaluation values, such as mileage relating to eco-driving, on the basis of the information relating to the condition in which the vehicle of each user is driven or the driving operation of the driver recorded in the user's entire traveling history DB 221.

The eco-driving awareness pre-learning unit 241 calculates the eco-driving awareness pre-learning result, which is used to estimate the eco-driving awareness in the vehicle-mounted system 100, on the basis of the information relating to the condition in which the vehicle of each user is driven or the driving operation of the driver recorded in the user's entire traveling history DB 221.

The eco-driving capability DB 251 records the eco-driving probability density estimated by the eco-driving probability density estimation unit 231. The eco-driving awareness pre-learning result DB 261 records the eco-driving pre-learning result calculated by the eco-driving awareness pre-learning unit 241. The eco-driving probability density recorded in the eco-driving capability DB 251 and the eco-driving awareness pre-learning result recorded in the eco-driving awareness pre-learning result DB 261 are transmitted to the vehicle-mounted system 100 by the communication control unit 211.

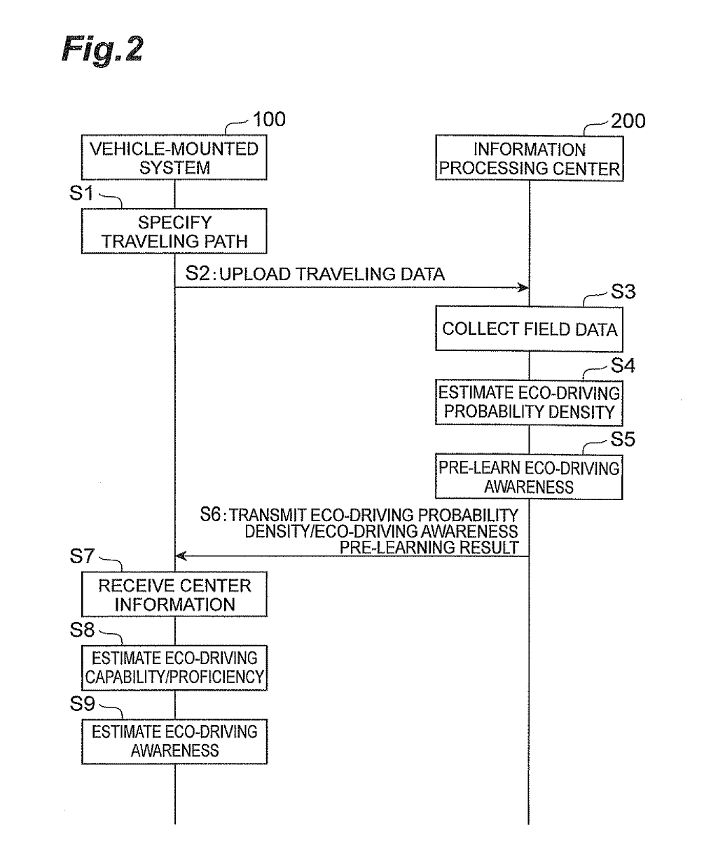

Hereinafter, the operation of the driving evaluation system 10 of this embodiment will be described. First, the outline of the operation of the driving evaluation system 10 of this embodiment will be described with reference to FIG. 2. As shown in FIG. 2, the scene specification unit 121 of the vehicle-mounted system 100 uses positional information of the host vehicle specified by the GPS 117 or the like or map information to specify the traveling road of the host vehicle (S1). As a method of specifying a traveling road, a method of specifying a traveling road by the positional information of the GPS 117, a specification method for each path in the map information, a specification method for each time, and a specification method for each distance are considered. A method of specifying a traveling road is determined depending on communication constraints to the amount of data to be uploaded to the information processing center 200 or the amount of data which is used for eco-driving capability/proficiency determination or eco-driving awareness estimation and the amount of information which is presented to the driver.

The traveling data upload processing unit 131 of the vehicle-mounted system 100 converts the specified traveling road and the information relating to the condition in which the host vehicle is driven or the driving operation of the driver acquired by the accelerator opening sensors 111 to the GPS 117 in a formation to be uploaded to the information processing center 200. Converted data is uploaded to the information processing center 200 by the communication control unit 141 (S2). In this case, the format of data to be uploaded depends on communication constraint, or a process for eco-driving capability/proficiency determination or eco-driving awareness estimation. When there is communication constraint, the traveling data upload processing unit 131 converts data acquired by the accelerator opening sensors 111 to the GPS 117, such as an accelerator opening distribution or an acceleration distribution for each traveling path. However, when there is no communication constraint, data acquired by the accelerator opening sensors 111 to the GPS 117 may be directly uploaded to the information processing center 200.

The communication control unit 211 of the information processing center 200 receives uploaded data and records received data in the user's entire traveling history DB 221 (S3). In this way, in the information processing center 200, in addition to the host vehicle, similar data is collected from an unspecified number of users.

The eco-driving probability density estimation unit 231 of the information processing center 200 estimates eco-driving probability density on the basis of information recorded in the user's entire traveling history DB 221 (S4). As described below in detail, the eco-driving probability density is estimated by estimating the probability distribution of evaluation values, such as mileage, of the driving of an unspecified number of drivers using one or a plurality of observation variables, such as acceleration, speed, and accelerator opening, in a certain traveling path, at a certain position, or at a certain time. Meanwhile, in general, since vehicle characteristics changes between vehicle types, it is considered that probability distribution estimation is performed for each vehicle type.

The eco-driving awareness pre-learning unit 241 of the information processing center 200 calculates the eco-driving awareness pre-learning result on the basis of information recorded in the user's entire traveling history DB 221 (S5). As described below in detail, the eco-driving awareness pre-learning result is calculated by estimating the awareness of the driver about eco-driving from driving operations of a specified number of users or an unspecified number of drivers in a certain traveling path, at a certain position, or at a certain time.

The communication control unit 211 of the information processing center 200 performs a process for transmitting the eco-driving probability density estimated by the eco-driving probability density estimation unit 231 and the eco-driving awareness pre-learning result calculated by the eco-driving awareness pre-learning unit 241 to the vehicle-mounted system 100 (S6).

The communication control unit 141 of the vehicle-mounted system 100 receives the eco-driving probability density and the eco-driving awareness pre-learning result in a certain traveling path, at a certain position, or at a certain time transmitted from the information processing center 200, and records the eco-driving probability density and the eco-driving awareness pre-learning result in the eco-driving probability density/eco-driving awareness pre-learning result DB 151 (S7).

The eco-driving capability/proficiency estimation unit 161 of the vehicle-mounted system 100 compares the eco-driving probability density in a certain traveling path, at a certain position, or at a certain time with the driving of the driver of the host vehicle in the corresponding traveling path or the like, and calculates the eco-driving capability and proficiency (S8). The evaluation values for evaluating the driving of the driver are determined by a method of calculating eco-driving probability density in the eco-driving probability density estimation unit 231 of the information processing center 200 or a method of presenting information to the driver by the display 181 or the like of the vehicle-mounted system 100. Typically, as the evaluation values, mileage, accelerator opening, acceleration, and the like are used.

The eco-driving awareness estimation unit 171 of the vehicle-mounted system 100 estimates the eco-driving awareness of the driver from the eco-driving awareness pre-learning result in a certain traveling path, at a certain position, or at a certain time and the actual driving operation (accelerator operation, brake operation, or the like) of the driver in the corresponding traveling path or the like (S9).

Thereafter, the display 181 or the speaker 182 of the vehicle-mounted system 100 displays the eco-driving capability and proficiency calculated by the eco-driving capability/proficiency estimation unit 161 for the driver. The display 181 or the speaker 182 of the vehicle-mounted system 100 provides advice to the driver in accordance with the eco-driving awareness calculated by the eco-driving awareness estimation unit 171.

Hereinafter, in regard to the details of the operation of the driving evaluation system 10 of this embodiment, eco-driving probability density estimation of S4, eco-driving awareness pre-learning of S5, eco-driving capability/proficiency estimation of S8, and eco-driving awareness estimation of S9 in FIG. 2 will be described.

(Eco-Driving Probability Density Estimation)

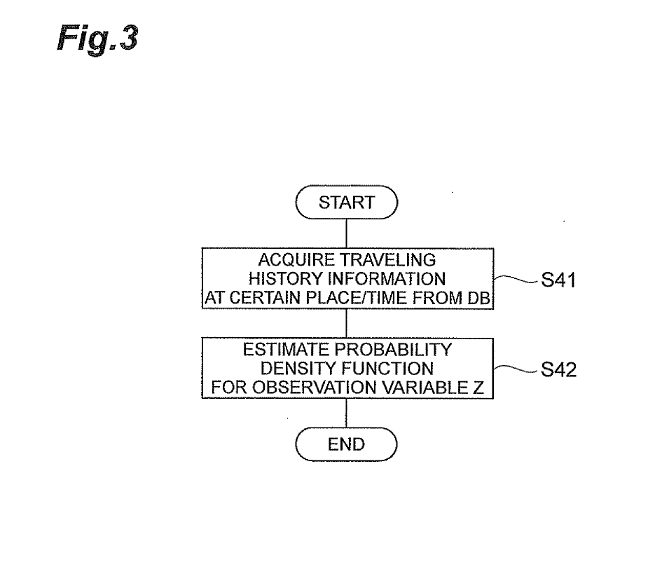

In the eco-driving probability density estimation of S4 in FIG. 2, as shown in FIG. 3, the eco-driving probability density estimation unit 231 acquires traveling history information at a certain place, a certain time, or the like from the user's entire traveling history DB 221 (S41). In this case, data of eco-driving capability derived by a previous process on the vehicle-mounted system 100 side is received by the information processing center 200, thereby obtaining traveling history information for each time, each vehicle, or the like.

The eco-driving probability density estimation unit 231 estimates the probability density function of the evaluation values of the driving for an observation variable Z (S42). The observation variable Z is a variable relating to a driving condition acquired from the user's entire traveling history DB. The observation variable Z is classified into a static ambient condition, such as road inclination or road alignment, an inter-vehicle distance from a preceding/succeeding vehicle, a dynamic ambient condition, such as congestion information, driving behavior, such as steering operation or accelerator opening, and a vehicle condition, such as speed or acceleration.

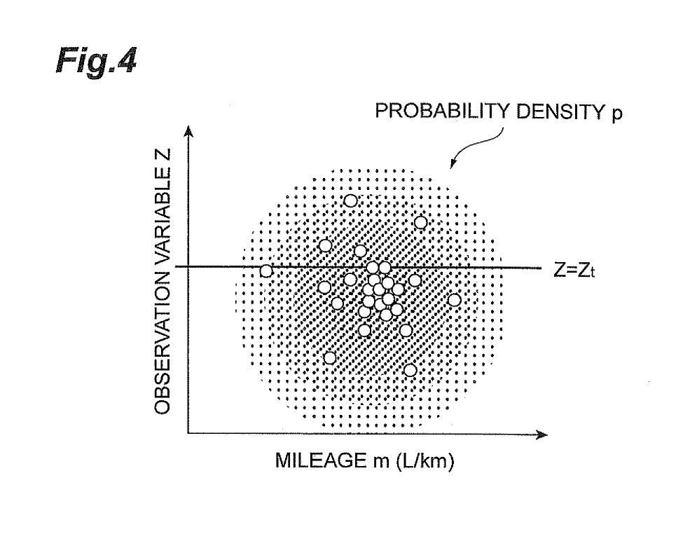

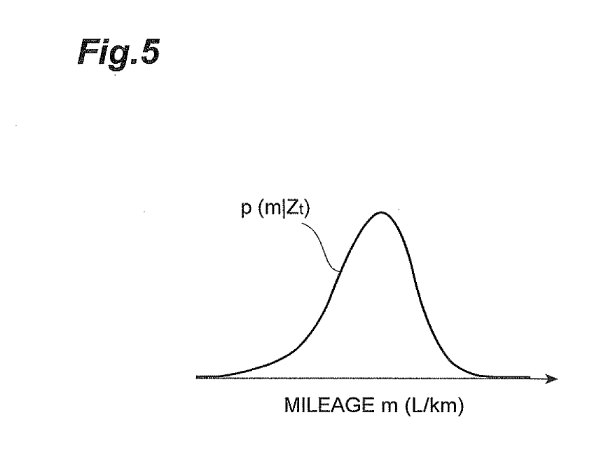

The eco-driving probability density estimation unit 231 estimates a probability density function p(m|Zₜ) shown in FIG. 5 for the observation variable Z in a condition shown in FIG. 4 in which the observation variable Z is Z=Zₜ at the time t. Although in the example shown in FIGS. 4 and 5, a parameter on the horizontal axis is mileage m (L/km) as an evaluation value of driving, a parameter, such as acceleration or accelerator opening, may be used.

The eco-driving probability density estimation unit 231 estimates the probability density function p by Kernel density estimation. Expression (1) expresses a probability density function p when the number of multivariables is k.

$$\begin{matrix}[ Equation 1 ] & \\ p ( x , μ , Σ ) = \frac{1}{{( 2 π )}^{k / 2} {\vert h Σ \vert}^{1 / 2}} {\sum }_{i = 1}^{N} exp [ - \frac{1}{2} {( x - {x}_{i} )}^{T} {( h Σ )}^{- 1} ( x - {x}_{i} ) ] & ( 1 )\end{matrix}$$

N: number of pieces of data
h: bandwidth
x=(x₁, x₂, . . . , xₖ)^{T}: multivariable vector

$$Σ = ( \begin{matrix}{σ}_{11} & {σ}_{12} & … & {σ}_{1 k} \\ {σ}_{21} & {σ}_{22} & … & {σ}_{2 k} \\ ⋮ & ⋮ & ⋱ & ⋮ \\ {σ}_{k 1} & {σ}_{k 2} & … & {σ}_{kk}\end{matrix} ) :$$

variance-covariance matrix
σₗₘ=σₗσₘρₗₘ (l, m=1 to k)

$${σ}_{1}^{2} = \frac{1}{N} {\sum }_{i = 1}^{N} {( {x}_{li} - {μ}_{l} )}^{2} \text{:}$$

sample variance
ρₗₘ: correlation function (ρₗ₁=1)
μ=(μ₁, μ₂, . . . , μₖ)^{T}: average vector

$$μ = \frac{1}{N} {\sum }_{i = 1}^{N} x$$

The eco-driving probability density estimation unit 231 may estimate the probability density function p using contaminated normal distribution approximation expressed by Expression (2). According to contaminated normal distribution approximation using an EM (Exception-Maximization) algorithm, the probability density function p is estimated in real time, making it possible to reduce the calculation time. According to Expression (2), N times of calculations are required so as to obtain the probability of one point. The probability of N points is N×N.

$$\begin{matrix}[ Equation 2 ] & \\ f ( x , Σ ) = \frac{1}{{( 2 π )}^{k / 2} {\vert Σ \vert}^{1 / 2}} {\sum }_{i = 1}^{N} exp [ - \frac{1}{2} {( x - {x}_{i} )}^{T} {Σ}^{- 1} ( x - {x}_{i} ) ] & ( 2 )\end{matrix}$$

According to Expression (3), N times of calculations are required so as to obtain the probability of one point. The probability of N points is N×M.

$$\begin{matrix} [ Equation 3 ] & \\ f ( x , {μ}_{r} , {ω}_{r} , {Σ}_{r} ) = {\sum }_{r = 1}^{M} \frac{1}{{( 2 π )}^{k / 2} {\vert {\sum }_{r} \vert}^{1 / 2}} {ω}_{r} exp [ - \frac{1}{2} {( x - {u}_{r} )}^{T} {{\sum }_{r}}^{- 1} ( x , {μ}_{r} ) ] & ( 3 )\end{matrix}$$

When initial values μᵣ and ωᵣ are given, a conditional probability pᵣ (Z=r) is expressed by Expression (4).

$$\begin{matrix}[ Equation 4 ] & \\ {p}_{r} ( Z = r ) = \frac{\frac{1}{{( 2 π )}^{k / 2} {\vert {Σ}_{r} \vert}^{1 / 2}} {ω}_{r} exp [ - \frac{1}{2} {( x - {u}_{r} )}^{T} {\sum }_{r}^{- 1} ( x , {μ}_{r} ) ]}{{\sum }_{r = 1}^{M} \frac{1}{{( 2 π )}^{k / 2} {\vert {Σ}_{r} \vert}^{1 / 2}} {ω}_{r} exp [ - \frac{1}{2} {( x - {u}_{r} )}^{T} {{\sum }_{r}}^{- 1} ( x , {μ}_{r} ) ]} & ( 4 )\end{matrix}$$

An update value is expressed by Expression (5). The calculation by Expression (4) is repeated again.

$$\begin{matrix}[ Equation 5 ] & \\ {ω}_{r}^{( 1 )} = \frac{1}{N} {\sum }_{t = 1}^{N} {p}_{i} ( Z = r ) , {μ}_{r}^{( 1 )} = \frac{1}{N {ω}_{r}^{( 1 )}} {\sum }_{r = 1}^{N} {x}_{i} {p}_{i} ( Z = r ) \\ {V}_{r}^{( 1 )} = \frac{1}{N {ω}_{r}^{( 1 )}} {\sum }_{t = 1}^{N} {p}_{i} ( Z = r ) ( {x}_{i} - {μ}_{r} ) ( {x}_{i} - {μ}_{r} ) T & ( 5 )\end{matrix}$$

Although in the above-described example, the probability density function p is estimated from data of an unspecified number of users, the probability density function p may be estimated on the basis of data specific to the driver of the host vehicle.

(Eco-Driving Awareness Pre-Learning)

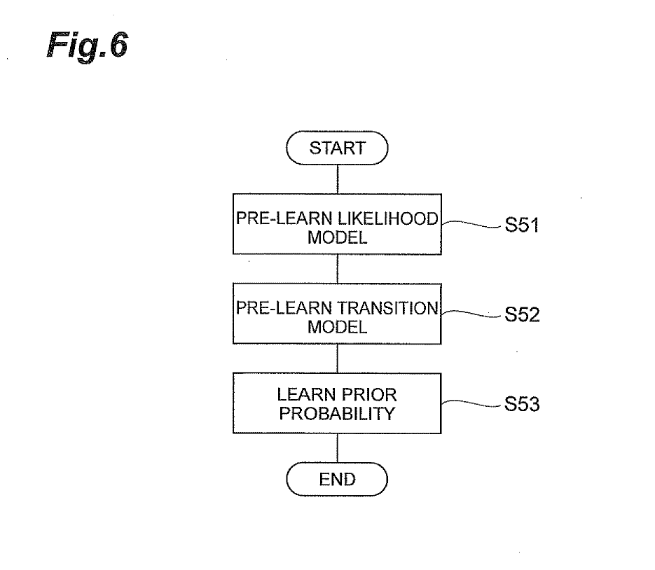

In the eco-driving awareness pre-learning of S5 in FIG. 2, As shown in FIG. 6, the eco-driving awareness pre-learning unit 241 of the information processing center 200 calculates learning data of eco-driving awareness specific to the driver of the host vehicle or learning data of eco-driving awareness of an unspecified number of drivers using a dynamic Bayesian network method. As shown in FIGS. 1 and 2, data which is used for learning using the dynamic Bayesian network or a support vector machine described below may be collected as field data from a vehicle traveling on an actual road or may be learned from collected data.

As shown in FIG. 6, in the eco-driving awareness pre-learning by the dynamic Bayesian network method, the eco-driving awareness pre-learning unit 241 performs pre-learning of a likelihood model (S51). The eco-driving awareness pre-learning unit 241 performs learning of a transition model (S52). The eco-driving awareness pre-learning unit 241 performs learning of a prior probability of an awareness state (S53).

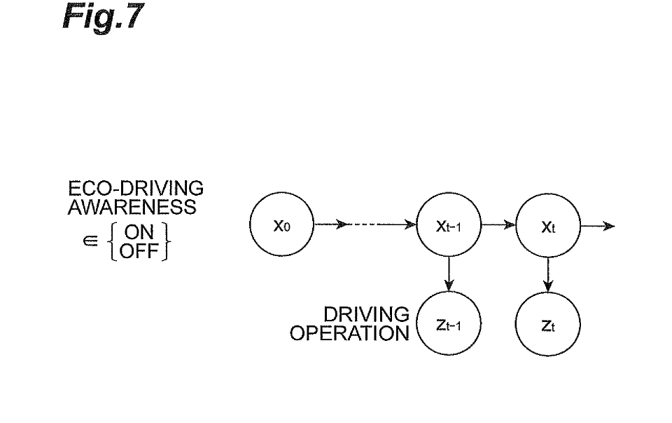

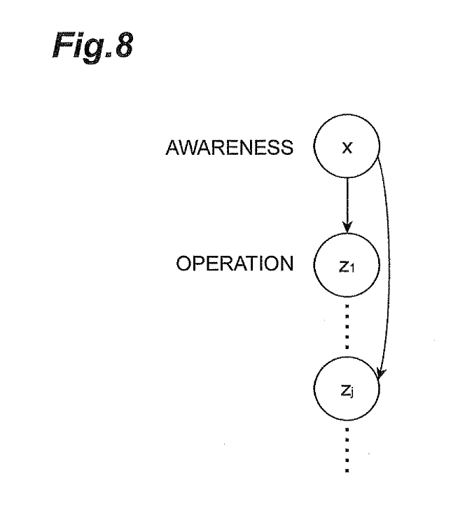

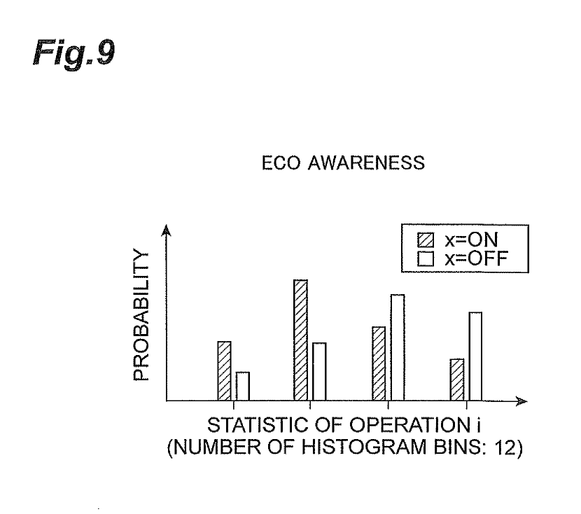

As shown in FIG. 7, the likelihood of an awareness state xₜ for a collection of driving operations zₜ is defined as p(zₜ|xₜ). Examples of the driving operations zₜ, as shown in FIG. 8 include an accelerator opening z₁, a brake step-in amount z₂, and the like, and an instantaneous value or a statistic at a certain point (standard deviation or the like) is used. A certain point may be defined by information of the corresponding point by information of the GPS 117 of the vehicle-mounted system 100, information of the corresponding point after correction based on road information of map data, information of a traveling path of map data, a given distance which can be arbitrarily determined, or the like. A likelihood distribution can be modeled in a histogram shown in FIG. 9 by Expression (6) assuming independence between the driving operations zₜ.

$$\begin{matrix}[ Equation 6 ] & \\ p ( z \vert x {\prod }_{i = 1}^{D} p ( {z}_{i} \vert x ) & ( 6 )\end{matrix}$$

A transition model of an awareness state x is defined as p(xₜ|xₜ₋₁). In this case, a primary Markov chain is assumed. Meanwhile, a higher-order model may be assumed. The prior probability of the awareness state x is defined as p(x₀). The definition is made as follows.

n: n-th traveling data
N: number of pieces of traveling data
τ: frame number in target traveling data
Tₙ: number of frames in n-th traveling data
z_{i,n,τ}: statistic of driving operation i in τ-th frame of n-th traveling data
x_{n,τ}: eco awareness state in τ-th frame of n-th traveling data
δ(C): function which returns 1 if condition C is true and returns 0 if condition C is false

The pre-learning of the likelihood model can be performed as in Expression (7).

$$\begin{matrix}[ Equation 7 ] & \\ P ( {z}_{r} = η \vert x = ξ ) = \frac{{\sum }_{N = 1}^{N} {\sum }_{r = Δ T - 1}^{Tn} δ ( {z}_{1 , Nr} = η , {x}_{x , T} = ξ}{{\sum }_{n = 1}^{N} {\sum }_{r = Δ T - 1}^{Tn} δ ( {x}_{n , r} = ξ} & ( 7 )\end{matrix}$$

The learning of the transition model can be performed as in Expression (8).

$$\begin{matrix}[ Equation 8 ] & \\ P ( {x}_{t} = {ξ}_{1} \vert {x}_{t = 1} = {ξ}_{2} ) = \frac{{\sum }_{N = 1}^{N} {{\sum }_{t = 2}}^{Tn} δ ( {x}_{n , T} = {ξ}_{1} , {x}_{n , r = 1} = {ξ}_{2} )}{{\sum }_{n = 1}^{N} {\sum }_{t = 2}^{Tn} δ ( {x}_{n , r - 1} = {ξ}_{2} )} & ( 8 )\end{matrix}$$

The learning of the prior probability of the awareness state x can be performed as in Expression (9).

$$\begin{matrix}[ Equation 9 ] & \\ P ( {X}_{0} ) = ξ = \frac{{\sum }_{n = 1}^{N} {\sum }_{r = 1}^{Tn} δ ( {x}_{n , r} = ξ )}{{\sum }_{n = 1}^{N} {\sum }_{t = 1}^{Tn} 1} & ( 9 )\end{matrix}$$

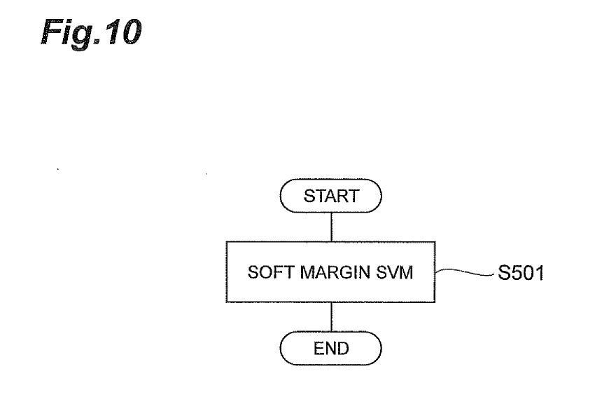

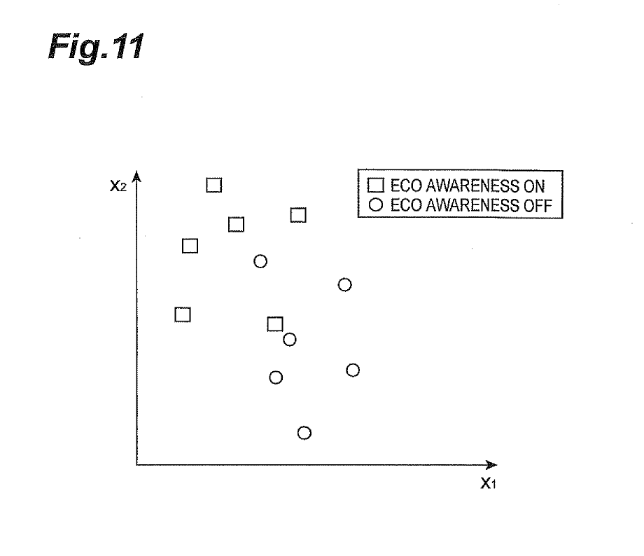

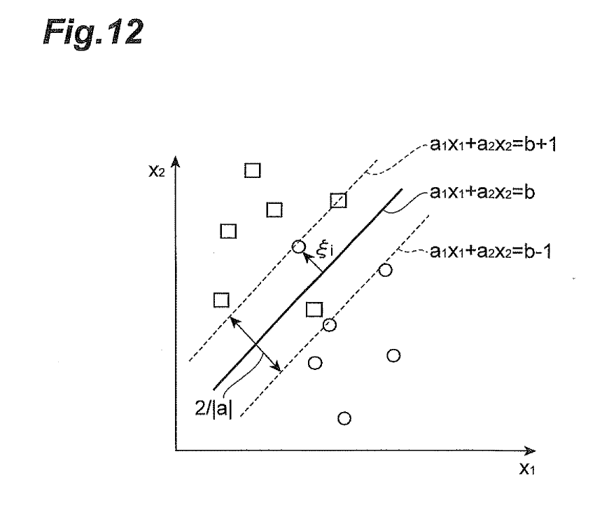

As shown in FIG. 10, the eco-driving awareness pre-learning unit 241 may perform eco-driving awareness pre-learning using a support vector machine (Support Vector Machine: hereinafter, called SVM) (S501). FIG. 11 shows an example where data for two observation variables x₁ and x₂ are obtained. If the method of the soft margin SVM is applied to data of FIG. 11 as the distance between a function, which classifies x=[x₁ x₂]^{T}, a=[a₁ a₂]^{T}, and ξᵢ into two classes, and data, the result is as shown in FIG. 12. In the soft margin SVM shown in FIG. 12, a and b are obtained such that an evaluation function L shown in Expression (10) is minimized, and the boundary between eco awareness ON and OFF is obtained. In Expression (10), l is the number of pieces of data surpassed the margin, and C is the weight of cost which surpasses the margin (penalty parameter, constant). C is a constant and arbitrarily determined such that classification is optimized.

$$\begin{matrix}[ Equation 10 ] & \\ L = \frac{1}{2} {\vert α \vert}^{2} + C {\sum }_{t = 1}^{l} {ξ}_{i} & ( 10 )\end{matrix}$$

In the above-described eco-driving awareness pre-learning, it is possible to calculate a model specialized for an individual driver using only personal data of the driver of the host vehicle. In this case, it is advantageous in that recognition precision for the corresponding driver increases. A general-purpose model may be calculated using data of an unspecified number of drivers. In this case, it is advantageous in that recognition can immediately start for an unknown driver.

(Eco-Driving Capability/Proficiency Estimation)

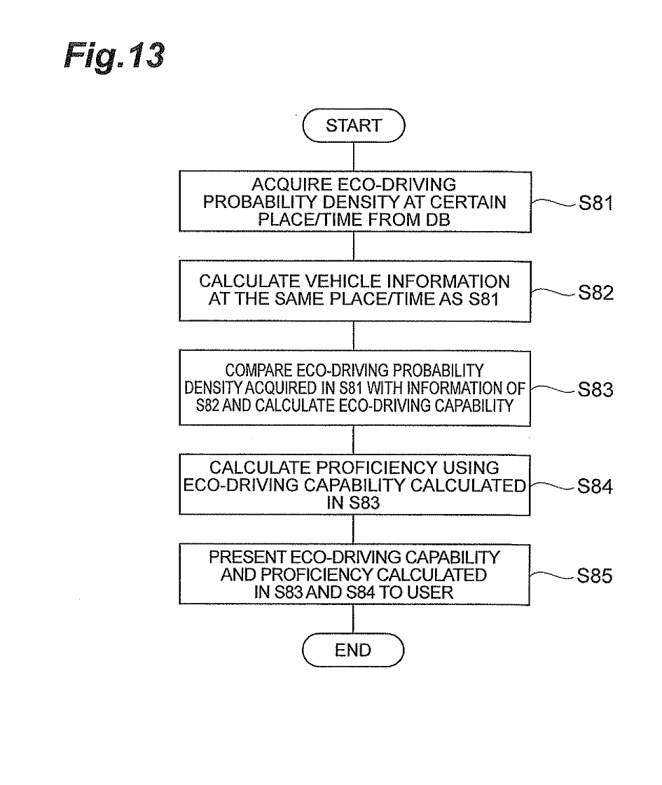

In the eco-driving capability/proficiency estimation of S8 in FIG. 2, as shown in FIG. 13, the eco-driving capability/proficiency estimation unit 161 of the vehicle-mounted system 100 acquires the eco-driving capability at certain place and time from the eco-driving probability density/eco-driving awareness pre-learning result DB 151 (S81). The certain place can be defined by information of the corresponding point by information of the GPS 117 of the vehicle-mounted system 100, information of the corresponding point after correction based on road information of map data, information of a traveling path of map data, a given distance which can be arbitrarily determined, or the like. Similarly, the certain time can be defined by a time period which is arbitrarily determined. The process in S81 is defined as described above, and is a process in which information regarding the probability density estimated in the eco-driving probability density estimation of S4 in FIG. 2 is acquired from the eco-driving probability density/eco-driving awareness pre-learning result DB 151.

The eco-driving capability/proficiency estimation unit 161 calculates information of the host vehicle obtained from the accelerator opening sensor 111 to the GPS 117 at the same place and time as the certain place and time (S82). Since information which is presented to the driver of the host vehicle as the user, the proficiency based on mileage, mileage is calculated. Meanwhile, since the eco-driving capability and the proficiency based on eco-driving, such as previous and subsequent acceleration, accelerator opening, or brake control input, may be calculated, in this case, these pieces of information are calculated.

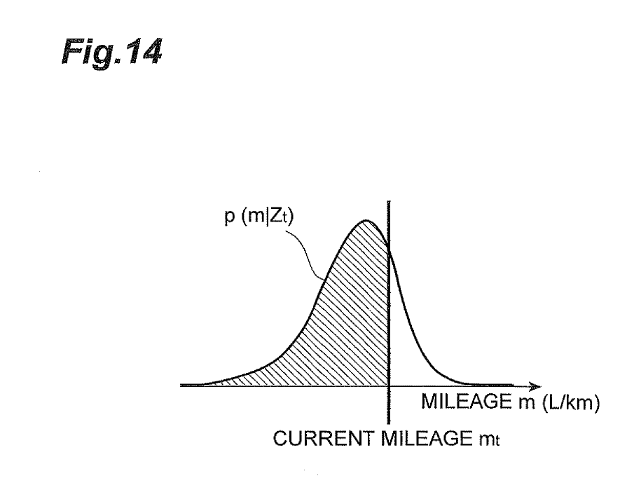

The eco-driving capability/proficiency estimation unit 161 compares the eco-driving probability density acquired in S81 with information of the host vehicle calculated in S82, and calculates the eco-driving capability (S83). The eco-driving capability cₜ at certain place and time is obtained by FIG. 14 and Expression (11). In this case, the certain place can be defined by information of the corresponding point by information of the GPS 117 of the vehicle-mounted system 100, information of the corresponding point after correction based on road information of map data, information of a traveling path of map data, a given distance which can be arbitrarily determined, or the like. Similarly, the certain time can be defined by a time period which is arbitrarily determined. Although in the example of FIG. 14, mileage [L/km] is used as an evaluation value of eco-driving, other parameters, such as acceleration and accelerator opening, may be used.

$$\begin{matrix}[ Equation 11 ] & \\ {c}_{t} = \frac{{\int }_{0}^{m} p ( m \vert {Z}_{r} ) d m}{{\int }_{0}^{⊗} p ( m \vert {Z}_{t} ) d m} \times 100 [ \% ] & ( 11 )\end{matrix}$$

The eco-driving capability/proficiency estimation unit 161 calculates the proficiency using the eco-driving capability calculated in S83 (S84). In this case, as the calculation method, the methods of Expressions (12) to (15) are considered.

[Equation 12]

when directly calculating from capability

s=100−cₜ [%] (12)

when expressed by average value at given time

s=avg[100−cₜ]_{t-Δt}^{t} [%] (13)

when expressed using maximum capability at given time

s=[100−max{cₜ}]_{t-Δt}^{t} [%] (14)

when expressed using minimum capability at given time

s=[100−min{cₜ}]_{t-Δt}^{t} [%] (15)

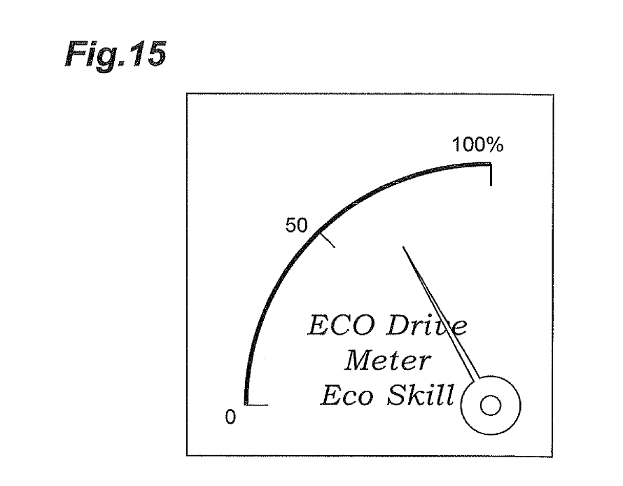

The eco-driving capability/proficiency estimation unit 161 displays the eco-driving capability and proficiency obtained in S83 and S84 on the display 181 or the like for the driver of the host vehicle as the user (S85). The display on the display 181 can be performed modeling, for example, display by a meter shown in FIG. 15. The presentation of the eco-driving capability and proficiency to the user is not limited to the mode shown in FIG. 15, and can be performed by outputting characters or sound from the display 181 or the speaker 182.

(Eco-Driving Awareness Estimation)

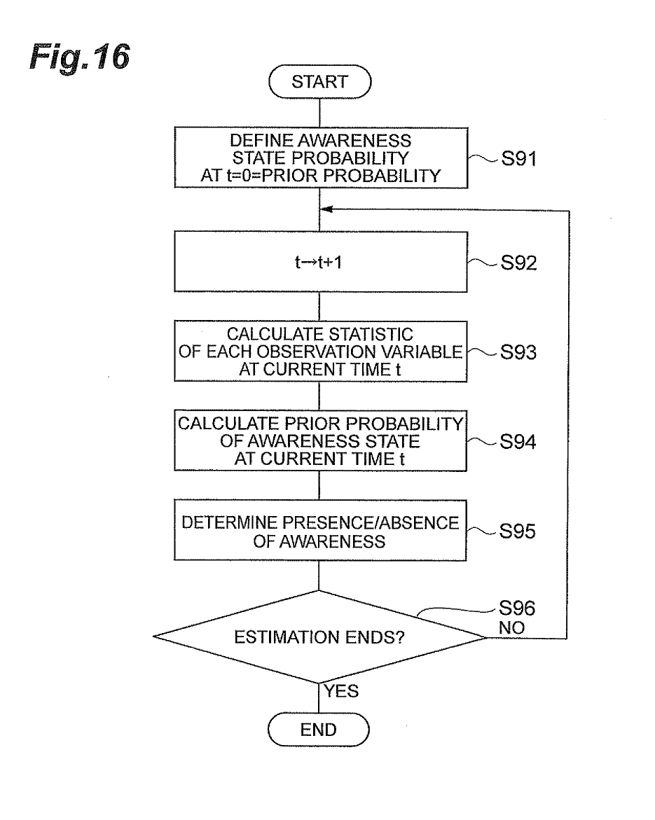

In the eco-driving awareness estimation of S9 in FIG. 2, as shown in FIG. 16, the eco-driving awareness estimation unit 171 of the vehicle-mounted system 100 estimates the eco-driving awareness of the driver of the host vehicle using the dynamic Bayesian network method. The eco-driving awareness estimation unit 171 sets the awareness state probability at the time t=0=the prior probability (S91). The eco-driving awareness estimation unit 171 adds 1 to t (S92).

The eco-driving awareness estimation unit 171 calculates the statistic of each observation variable at the current time t (S93). As the observation variable, for example, the accelerator opening, the brake step-in amount, or the like which is information regarding driving of the host vehicle at a certain point is used. The certain point can be defined by information of the corresponding point by information of the GPS 117 of the vehicle-mounted system 100, information of the corresponding point after correction based on road information of map data, information of a traveling road of map data, a given distance which can be arbitrarily determined, or the like. When the statistic of each observation variable at the current time t is a statistic z_{i,t} of an observation variable i at the current time t, an instantaneous value, a moving standard deviation, and the like are considered. If the observed value of the observation variable i at the current time t is O_{i,t}, the instantaneous value and the moving standard deviation of the statistic z_{i,t} can be calculated by Expression (16).

$$\begin{matrix}[ Equation 13 ] & \\ INSTANTANEOUS VALUE \text{:} {z}_{i , t} = {O}_{i , t} \\ MOVING STANDARDDEVIATION \text{:} \\ {z}_{i , t} = \sqrt{\frac{1}{Δ T} {\sum }_{τ = 0}^{Δ T - 1} {( {O}_{i , t - τ} - {\overline{O}}_{i , t} )}^{2}} \\ MOVING AVERAGE \text{:} \\ {\overline{O}}_{i , t} = \frac{1}{Δ T} {\sum }_{τ = 0}^{Δ T - 1} {O}_{i , t - τ} TIME WINDOW SIZE \text{:} Δ T & ( 16 )\end{matrix}$$

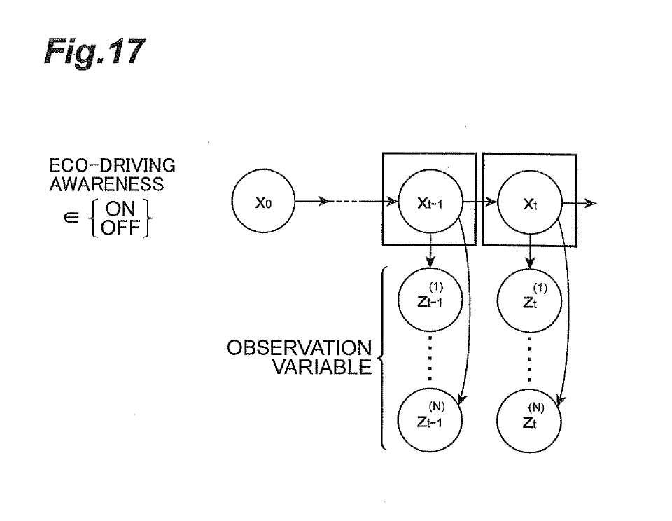

The eco-driving awareness estimation unit 171 calculates the posterior probability of the awareness state at the current time shown in FIG. 17 (S94). The posterior probability can be calculated by Expression (17). As described above, in Expression (17), p(zₜ|xₜ) is likelihood with respect to the observed value zₜ of the awareness state xₜ, and P(xₜ|xₜ₋₁) is a transition model of the awareness state x.

$$\begin{matrix}[ Equation 14 ] & \\ P ( {x}_{t} \vert {Z}_{l : t} ) = α p ( {z}_{t} \vert {x}_{t} ) {\sum }_{{x}_{t - 1}} P ( {x}_{t} \vert {x}_{t - 1} ) P ( {x}_{t - 1} \vert {z}_{l : t - 1} ) & ( 17 )\end{matrix}$$

The eco-driving awareness estimation unit 171 determines the presence/absence of eco awareness (S95). The determination of the presence/absence of eco awareness can be calculated by Expression (18). The eco-driving awareness estimation unit 171 repeats the process of S92 to S95 until estimation ends (S96).

$$\begin{matrix}[ Equation 15 ] & \\ IN {x}_{t} ∈ \{ ON , OFF \} , \\ STATE WHERE POSTERIOR PROBABILITY IS MAXIMUM IS DEFINED AS ESTIMATED \\ ECO STATE {\hat{x}}_{t} . FOLLOWING EXPRESSION \\ IS ESTABLISHED . \\ {\hat{x}}_{t} = arg {max}_{{x}_{t}} P ( {x}_{t} \vert {z}_{l : t} ) & ( 18 )\end{matrix}$$

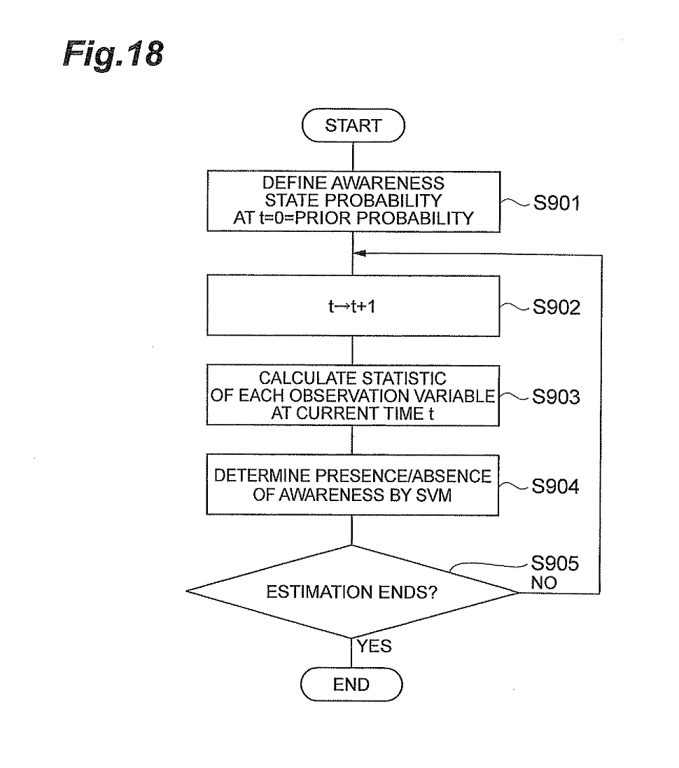

As shown in FIG. 18, the eco-driving awareness estimation unit 171 may perform the eco-driving awareness estimation using the support vector machine. The eco-driving awareness estimation unit 171 sets the awareness state probability at the time t=0=prior probability (S901). The eco-driving awareness estimation unit 171 adds 1 to t (S902). Similarly to the dynamic Bayesian network, the eco-driving awareness estimation unit 171 calculates the statistic of each observation variable at the current time t (S903).

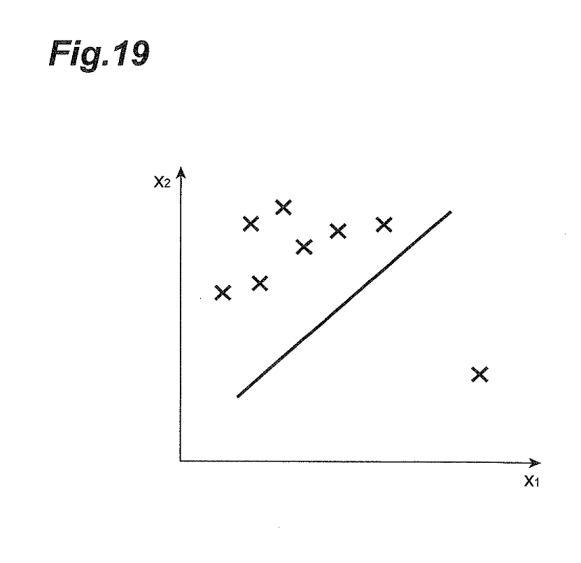

The eco-driving awareness estimation unit 171 determines the presence/absence of eco-awareness by SVM (S904). As shown in FIG. 12, the presence/absence of eco awareness is determined using a classification function of the presence/absence of eco awareness obtained from the pre-learning result using the soft margin SVM by the pre-learning unit 241 of the information processing center 200. FIG. 19 shows the determination result of the presence/absence of eco awareness, and shows an example where there are two observation variables and it is determined that eco awareness is given. Input data plotted in FIG. 19 is the statistic of the observation variable obtained in S903. When input data is classified by the classification function of the eco-driving awareness into a class in which eco-driving awareness is given, the eco-driving awareness estimation unit 171 determines that there is eco-driving awareness. The eco-driving awareness estimation unit 171 repeats the process of S92 to S95 until estimation ends (S905).

According to this embodiment, the eco-driving probability density estimation unit 231 and the eco-driving awareness pre-learning unit 241 reset the evaluation standard of the driving of the driver of the host vehicle for each condition, in which the host vehicle is driven, for each driving evaluation. For this reason, it becomes possible to set the evaluation standard of the driving suitable for the actual condition at the time of evaluation compared to the standard for uniformly evaluating the driving is set. The eco-driving capability/proficiency estimation unit 161 and the eco-driving awareness estimation unit 171 evaluate the driving of the host vehicle by the evaluation standard reset by the eco-driving probability density estimation unit 231 and the eco-driving awareness pre-learning unit 241. For this reason, it becomes possible to perform driving evaluation more suitable for the actual condition.

According to this embodiment, the eco-driving probability density estimation unit 231 estimates, as the evaluation standard, the probability distribution of the evaluation values of the driving for each condition in which the host vehicle is driven. For this reason, it is possible to statistically quantify the difficulty of driving in the corresponding condition. The eco-driving capability/proficiency estimation unit 161 evaluates the driving of the driver of the host vehicle on the basis of the probability distribution of the evaluation values in the condition in which the host vehicle is driven and the evaluation values of actual driving of the host vehicle in which the host vehicle is driven, making it possible to perform driving evaluation more suitable for the actual condition quantitatively on the basis of the statistic.

According to this embodiment, the eco-driving probability density estimation unit 231 estimates, as the evaluation standard, the probability distribution of the evaluation values of the driving of an unspecified number of vehicles for each condition in which the host vehicle is driven. For this reason, in regard to the evaluation standard of the driving, it is possible to quantify the difficulty of driving in the corresponding condition more suitable for the actual condition on the basis of the statistic of driving of an unspecified number of vehicles.

According to this embodiment, the eco-driving probability density estimation unit 231 estimates, as the evaluation standard, the probability density function relating to the probability distribution of the evaluation values of the driving for each condition, in which the host vehicle is driven, by Kernel density estimation.

Alternatively, according to this embodiment, the eco-driving probability density estimation unit 231 estimates, as the evaluation standard, the probability density function relating to the probability distribution of the evaluation values of the driving for each condition in which the host vehicle is driven or the driving of an unspecified number of drivers of the vehicles of the same type, by approximation based on the contaminated normal distribution. With the contaminated normal distribution, the number of samples can be reduced. For this reason, it becomes possible to reduce the calculation time for estimating the probability density function.

According to this embodiment, the eco-driving awareness pre-learning unit 241 estimates, as the evaluation standard, the awareness state of the driver of the host vehicle for each condition, in which the host vehicle is driven, from the driving operation for each condition in which the host vehicle is driven. For this reason, it is possible to appropriately estimate the awareness state of the driver in the corresponding condition. The eco-driving awareness estimation unit 171 evaluates the driving of the driver of the host vehicle on the basis of the awareness state of the driver of the host vehicle estimated in the condition in which the host vehicle is driven and the actual driving operation of the driver of the host vehicle in the condition in which the host vehicle is driven. For this reason, it is possible to evaluate the driving of the driver in the relation between the awareness state of the driver and the actual driving operation, making it possible to perform driving evaluation including the awareness of the driver about driving.

According to this embodiment, the eco-driving awareness pre-learning unit 241 estimates, as the evaluation standard, the awareness state of the driver of the host vehicle for each condition, in which the host vehicle is driven, from the statistic of the driving operation of the driver of the host vehicle for each condition in which the host vehicle is driven. For this reason, it becomes possible to estimate the awareness state for the driver himself/herself of the host vehicle with high precision.

Alternatively, according to this embodiment, the eco-driving awareness pre-learning unit 241 estimates, as the evaluation standard, the awareness state of the driver of the host vehicle for each condition, in which the host vehicle is driven, from the statistic of the driving operations of the driver of an unspecified number of vehicles for each condition in which the host vehicle is driven. For this reason, even if a small amount of data is accumulated for the driver himself/herself of the host vehicle, it becomes possible to immediately estimate the awareness state of the driver of the host vehicle.

According to this embodiment, the eco-driving awareness pre-learning unit 241 estimates the awareness state of the driver of the host vehicle by the dynamic Bayesian network. For this reason, it becomes possible to quantitatively estimate the causal relation of the driving operation with respect to the awareness state of the driver.

Alternatively, according to this embodiment, the eco-driving awareness pre-learning unit 241 estimates the awareness state of the driver of the host vehicle by the support vector machine. For this reason, even if a small amount of data is accumulated for estimation, it becomes possible to estimate the awareness state of the driver.

According to this embodiment, the condition in which the host vehicle is driven includes the place and time at which the host vehicle is driven. For this reason, it is possible to evaluate the driving of the driver for the time and place at which the vehicle is driven.

Since the driving evaluation system 10, the vehicle-mounted system 100, and the information processing center 200 of this embodiment can perform driving evaluation more suitable for the actual condition, the driver feels little sense of discomfort in the system and is likely to keep using the system. For this reason, it particularly becomes effective when eco-driving where efforts over a long period of time are important is evaluated.

The invention is not limited to the above-described embodiment, and may be of course modified in various ways within the scope without departing from the subject matter of the invention. For example, although in the foregoing embodiment, the exchange of information, such as the eco-driving probability density and the eco-driving awareness pre-learning result, between the vehicle-mounted system 100 and the information processing center 200 may be performed through wireless communication by the communication control units 141 and 211, according to the invention, the information exchange may be performed when the driver attaches a removable medium, such as a flexible disk, an optical-magnetic disc, a CD-R, a flash memory, a USB memory, or a removable hard disk, to a terminal which is connectable to the information processing center 200.

In the foregoing embodiment, the components in the vehicle-mounted system 100 and the information processing center 200 may be provided in either the vehicle-mounted system 100 or the information processing center 200. For example, only the sensors, such as the accelerator opening sensor 111, a display unit, such as the display 171, or the driver, and the communication control unit 141 may be mounted in the vehicle-mounted system 100, and all other components may be provided in the information processing center 200. Alternatively, a mode in which the information processing center 200 is not used, and all the components of the driving evaluation system 10 are provided only in the vehicle-mounted system 100 also falls within the scope of the invention.

### INDUSTRIAL APPLICABILITY

According to the driving evaluation system, the vehicle-mounted machine, and the information processing center of the invention, it becomes possible to perform driving evaluation more suitable for the actual condition.

### REFERENCE SIGNS LIST

10: driving evaluation system
100: vehicle-mounted system
111: accelerator opening sensor
112: fuel ejection amount sensor
113: brake sensor
114: vehicle speed sensor
115: engine speed sensor
116: G sensor
117: GPS
118: inter-vehicle distance measurement device
119: VMS
121: scene specification unit
131: traveling data upload processing unit
141: communication control unit
151: eco-driving probability density/eco-driving awareness pre-learning result DB
161: eco-driving capability/proficiency estimation unit
171: eco-driving awareness estimation unit
181: display
182: speaker
200: information processing center
211: communication control unit
221: user's entire traveling history DB
231: eco-driving probability density estimation unit
241: eco-driving awareness pre-learning unit
251: eco-driving capability DB
261: eco-driving awareness pre-learning result DB

1. (canceled)

2. A driving evaluation system comprising:
an evaluation standard resetting unit which resets an evaluation standard of driving of a driver of one vehicle for each condition in which the one vehicle is driven for each driving evaluation;
an evaluation unit which evaluates the driving of the driver of the one vehicle by the evaluation standard reset by the evaluation standard resetting unit; and
wherein the evaluation unit evaluates the driving of the driver of the one vehicle on the basis of the probability distribution of the evaluation values in the condition in which the one vehicle is driven and evaluation values of actual driving of the one vehicle in the condition in which the one vehicle is driven.

3. The driving evaluation system according to claim 2,
wherein the evaluation standard resetting unit estimates, as the evaluation standard, the probability distribution of evaluation values of driving of at least one of an unspecified number of vehicles for each condition in which the one vehicle is driven and an unspecified number of vehicles of the same type as the one vehicle for each condition in which the one vehicle is driven.

4. The driving evaluation system according to claim 2,
wherein the evaluation standard resetting unit estimates, as the evaluation standard, a probability density function relating to the probability distribution of evaluation values of driving for each condition, in which the one vehicle is driven, by Kernel density estimation.

5. The driving evaluation system according to claim 2,
wherein the evaluation standard resetting unit estimates, as the evaluation standard, a probability density function relating to the probability distribution of the evaluation values of the driving for each condition, in which the one vehicle is driven, by approximation based on a contaminated normal distribution.

6. The driving evaluation system according to claim 2,
wherein the evaluation standard resetting unit estimates, as the evaluation standard, the awareness state of the driver of the one vehicle for each condition, in which the one vehicle is driven, from a driving operation for each condition in which the one vehicle is driven, and
the evaluation unit evaluates the driving of the driver of the one vehicle on the basis of the awareness state of the driver of the one vehicle estimated in the condition in which the one vehicle is driven and an actual driving operation of the driver of the one vehicle in the condition in which the one vehicle is driven.

7. The driving evaluation system according to claim 6,
wherein the evaluation standard resetting unit estimates, as the evaluation standard, the awareness state of the driver of the one vehicle for each condition, in which the one vehicle is driven, from the statistic of the driving operation of the driver of the one vehicle for each condition in which the one vehicle is driven.

8. The driving evaluation system according to claim 6,
wherein the evaluation standard resetting unit estimates, as the evaluation standard, the awareness state of the driver of the one vehicle for each condition, in which the one vehicle is driven, from the statistic of driving operations of drivers of an unspecified number of vehicles for each condition in which the one vehicle is driven.

9. (canceled)

10. (canceled)

11. The driving evaluation system according to claim 2,
wherein the condition in which the one vehicle is driven includes at least one of the time and place at which the one vehicle is driven.

12. The driving evaluation system according to claim 2,
wherein the evaluation unit evaluates the degree such that the driving of the driver of the one vehicle attains low fuel consumption.

13. (canceled)

14. A vehicle-mounted machine comprising:
an evaluation unit which, for each condition in which a host vehicle is driven, evaluates driving of a driver of a host vehicle by an evaluation standard of the driving of the driver of the host vehicle reset for each driving evaluation; and
wherein the evaluation standard of the driving of the driver of the host vehicle is the probability distribution of evaluation values of driving estimated for each condition in which the host vehicle is driven, and the evaluation unit evaluates the driving of the driver of the host vehicle on the basis of the probability distribution of the evaluation values in the condition in which the host vehicle is driven and evaluation values of actual driving of the host vehicle in which the host vehicle is driven.

15. The vehicle-mounted machine according to claim 14,
wherein the evaluation standard of the driving of the driver of the host vehicle is the probability distribution of evaluation values of driving of at least one of an unspecified number of vehicles estimated for each condition in which the host vehicle is driven and an unspecified number of vehicles of the same type as the host vehicle for each condition in which the host vehicle is driven.

16. The vehicle-mounted machine according to claim 14,
wherein, as the evaluation standard of the driving of the driver of the host vehicle, a probability density function relating to the probability distribution of evaluation values of driving for each condition in which the host vehicle is driven is estimated by Kernel density estimation.

17. The vehicle-mounted machine according to claim 14,
wherein, as the evaluation standard of the driving of the driver of the host vehicle, a probability density function relating to the probability distribution of evaluation values of driving for each condition in which the host vehicle is driven is estimated by approximation based on a contaminated normal distribution.

18. The vehicle-mounted machine according to claim 14,
wherein the evaluation standard of the driving of the driver of the host vehicle is the awareness state of the driver of the host vehicle for each condition, in which the host vehicle is driven, estimated from a driving operation for each condition in which the host vehicle is driven, and
the evaluation unit evaluates the driving of the driver of the host vehicle on the basis of the awareness state of the driver of the host vehicle estimated in the condition in which the host vehicle is driven and an actual driving operation of the driver of the host vehicle in the condition in which the host vehicle is driven.

19. The vehicle-mounted machine according to claim 18,
wherein the evaluation standard of the driving of the driver of the host vehicle is the awareness state of the driver of the host vehicle for each condition, in which the host vehicle is driven, estimated from the statistic of driving operations of the driver of the host vehicle for each condition in which the host vehicle is driven.

20. The vehicle-mounted machine according to claim 18,
wherein the evaluation standard of the driving of the driver of the host vehicle is the awareness state of the driver of the host vehicle for each condition, in which the host vehicle is driven, estimated from the statistic of driving operations of drivers of an unspecified number of vehicles for each condition in which the host vehicle is driven.

21. (canceled)

22. (canceled)

23. The vehicle-mounted machine according to claim 14,
wherein the condition in which the host vehicle is driven includes at least one of the time and place at which the host vehicle is driven.

24. The vehicle-mounted machine according to claim 14,
wherein the evaluation unit evaluates the degree such that the driving of the driver of the host vehicle attains low fuel consumption.

25. (canceled)

26. An information processing center which sets an evaluation standard for evaluating driving of a driver of one vehicle, the information processing center comprising:
an evaluation standard resetting unit which resets the evaluation standard of the driving of the driver of the one vehicle for each condition, in which the one vehicle is driven, for each driving evaluation; and
wherein the evaluation standard resetting unit estimates, as the evaluation standard, the probability distribution of evaluation values of driving for each condition in which the one vehicle is driven.

27. The information processing center according to claim 26,
wherein the evaluation standard resetting unit estimates, as the evaluation standard, the probability distribution of evaluation values of driving of at least one of an unspecified number of vehicles for each condition in which the one vehicle is driven and an unspecified number of vehicles of the same type as the one vehicle for each condition in which the one vehicle is driven.

28. The information processing center according to claim 26,
wherein the evaluation standard resetting unit estimates, as the evaluation standard, a probability density function relating to the probability distribution of evaluation values of driving for each condition, in which the one vehicle is driven, by Kernel density estimation.

29. The information processing center according to claim 26,
wherein the evaluation standard resetting unit estimates, as the evaluation standard, a probability density function relating to the probability distribution of evaluation values of driving for each condition, in which the one vehicle is driven, by approximation based on a contaminated normal distribution.

30. The information processing center according to claim 26,
wherein the evaluation standard resetting unit estimates, as the evaluation standard, the awareness state of the driver of the one vehicle for each condition in which the one vehicle is driven from a driving operation for each condition in which the one vehicle is driven.

31. The information processing center according to claim 30,
wherein the evaluation standard resetting unit estimates, as the evaluation standard, the awareness state of the driver of the one vehicle for each condition in which the one vehicle is driven from the statistic of driving operations of the driver of the one vehicle for each condition in which the one vehicle is driven.

32. The information processing center according to claim 30,
wherein the evaluation standard resetting unit estimates, as the evaluation standard, the awareness state of the driver of the one vehicle for each condition in which the one vehicle is driven from the statistic of driving operations of drivers of an unspecified number of vehicles for each condition in which the one vehicle is driven.

33. (canceled)

34. (canceled)

35. The information processing center according to claim 26,
wherein the condition in which the one vehicle is driven includes at least one of the time and place at which the one vehicle is driven.

36. The information processing center according to claim 26,
wherein the evaluation standard is to evaluate the degree such that the driving of the driver of the one vehicle attains low fuel consumption.
